(19) United States
(12) Patent Application Publication
(10) Pub. No.: US 2015/0363667 A1
(43) Pub. Date: Dec. 17, 2015

(54) RECOGNITION DEVICE AND METHOD, AND COMPUTER PROGRAM PRODUCT

(71) Applicant: KABUSHIKI KAISHA TOSHIBA, Tokyo (JP)

(72) Inventors: Tomohiro Nakai, Kawasaki Kanagawa (JP); Susumu Kubota, Meguro Tokyo (JP); Satoshi Ito, Kawasaki Kanagawa (JP); Tomoki Watanabe, Inagi Tokyo (JP)

(21) Appl. No.: 14/721,045

(22) Filed: May 26, 2015

(30) Foreign Application Priority Data
May 26, 2014 (JP) 2014-108495

(51) Int. Cl. G06K 9/62

(52) U.S. Cl. CPC G06K 9/627; G06K 9/6256; G06K 9/6212; G06K 9/6215; G06K 9/6286

(57) ABSTRACT

According to an embodiment, a recognition device includes a memory to store therein learning patterns each belonging to one of categories; an obtaining unit to obtain a recognition target pattern; a first calculating unit to calculate, for each category, a distance histogram representing distribution of the number of learning patterns belonging to the categories with respect to distances between the recognition target pattern and the learning patterns belonging to the categories; a second calculating unit to analyze the distance histogram of each category, and calculate a feature value of the recognition target pattern; a third calculating unit to make use of the feature value and one or more classifiers, and calculate degrees of reliability of the recognition target categories; and a determining unit to make use of the degrees of reliability and, from among the one or more recognition target categories, determine a category of the recognition target pattern.

### CROSS-REFERENCE TO RELATED APPLICATIONS

This application is based upon and claims the benefit of priority from Japanese Patent Application No. 2014-108495, filed on May 26, 2014; the entire contents of which are incorporated herein by reference.

### FIELD

Embodiments described herein relate generally to a recognition device, a recognition method, and a computer program product.

### BACKGROUND

In pattern recognition, a method called k-nearest neighbors algorithm is known. In the k-nearest neighbors algorithm, from a plurality of learning patterns for which categories are known, top k number of learning patterns are retrieved that have shorter distances in the feature space to a recognition target pattern for which the category is not known; and the category to which the most number of learning patterns belong from among the k number of learning patterns is estimated to be the category of the recognition target pattern.

However, in the conventional technology explained above, since the recognition target pattern is evaluated using learning patterns equal in number to a limited neighborhood number k, it is not possible to evaluate the relationship with the entire category. Hence, there are times when it is difficult to perform accurate recognition. Besides, if the learning patterns include errors, then there is a risk for a decline in the robustness.

### BRIEF DESCRIPTION OF THE DRAWINGS

FIG. 1 is a configuration diagram illustrating an example of a recognition device according to a first embodiment;

FIG. 2 is an explanatory diagram for explaining an example of calculating distances between a recognition target pattern and learning patterns according to the first embodiment;

FIG. 3 is a diagram illustrating an example of distance histograms according to the first embodiment;

FIG. 4 is a flowchart for explaining a recognition operation performed according to the first embodiment;

FIG. 5 is a flowchart for explaining a category determination operation performed according to the first embodiment;

FIG. 6 is a configuration diagram illustrating an example of a recognition device according to a second embodiment;

FIG. 7 is a diagram illustrating an example of cumulative histograms according to the second embodiment;

FIG. 8 is a flowchart for explaining a recognition operation performed according to the second embodiment; and

FIG. 9 is a diagram illustrating an exemplary hardware configuration of the recognition device according to the embodiments and modification examples.

### DETAILED DESCRIPTION

According to an embodiment, a recognition device includes a first memory, an obtaining unit, a first calculating unit, a second calculating unit, a third calculating unit, a determining unit, and an output unit. The first memory stores therein a plurality of learning patterns each of which belongs to one of a plurality of categories. The obtaining unit obtains a recognition target pattern. The first calculating unit calculates, for each of the plurality of categories, a distance histogram which represents distribution of number of learning patterns belonging to the categories with respect to distances between the recognition target pattern and the learning patterns belonging to the categories. The second calculating unit analyzes the distance histogram of each of the plurality of categories, and calculates a feature value of the recognition target pattern. The third calculating unit makes use of the feature value and one or more classifiers used in classifying belongingness to one or more recognition target categories, and calculates degrees of reliability of the recognition target categories. The determining unit makes use of the degrees of reliability and, from among the one or more recognition target categories, determines a category of the recognition target pattern. The output unit outputs the determined category of the recognition target pattern.

Various embodiments will be described below in detail with reference to the accompanying drawings.

### First Embodiment

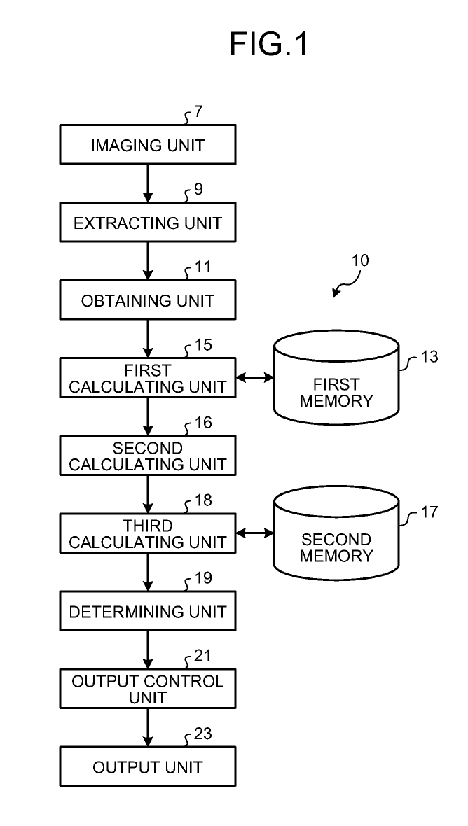

FIG. 1 is a configuration diagram illustrating an example of a recognition device 10 according to a first embodiment. As illustrated in FIG. 1, the recognition device 10 includes an imaging unit 7, an extracting unit 9, an obtaining unit 11, a first memory 13, a first calculating unit 15, a second calculating unit 16, a second memory 17, a third calculating unit 18, a determining unit 19, an output control unit 21, and an output unit 23.

The imaging unit 7 can be implemented using, for example, an imaging device such as a digital camera. The extracting unit 9, the obtaining unit 11, the first calculating unit 15, the second calculating unit 16, the third calculating unit 18, the determining unit 19, and the output control unit 21 can be implemented by executing computer programs in a processor such as a central processing unit (CPU), that is, can be implemented using software; or can be implemented using hardware such as an integrated circuit (IC); or can be implemented using a combination of software and hardware. The first memory 13 and the second memory 17 can be implemented using a memory device such as a hard disk drive (HDD), a solid state drive (SSD), a memory card, an optical disk, a random access memory (RAM), or a read only memory (ROM) in which information can be stored in a magnetic, optical, or electrical manner. The output unit 23 can be implemented using a display device such as a liquid crystal display or a display with a touch-sensitive panel, or can be implemented using a sound output device such as a speaker, or can be implemented using a combination of a display device and a sound output device.

The imaging unit 7 takes an image in which the recognition target object is captured. The extracting unit 9 extracts a recognition target pattern from the image taken by the imaging unit 7.

The obtaining unit 11 obtains the recognition target pattern extracted by the extracting unit 9. In the first embodiment, the recognition target pattern represents a feature vector extracted from the image in which the recognition target pattern is captured; and corresponds to, for example, an image feature value such as the histogram of oriented gradients (HOG).

Meanwhile, the recognition target pattern is not limited to a feature vector extracted from an image. Alternatively, for example, the recognition target pattern can be a feature vector extracted according to an arbitrary method from information obtained in an arbitrary manner using a microphone or a sensor.

The first memory 13 stores therein a plurality of learning (training) patterns each of which belongs to one of a plurality of categories. Herein, although it is assumed that each category has a plurality learning patterns belonging thereto; it does not exclude the case in which a category has a single learning pattern belonging thereto.

In the first embodiment, it is assumed that a learning pattern represents a feature vector extracted from an image capturing an object. However, that is not the only possible case. That is, as long as a learning pattern represents information corresponding to the recognition target pattern, it serves the purpose.

A category represents the type of an object (a learning pattern), and corresponds to unique information that is intrinsically latent in the object (the learning pattern). For example, if the object represents a person, then the learning pattern (the feature vector) based on the object belongs to a “person” category. If the object represents a road, then the learning pattern (the feature vector) based on the object belongs to a “road” category. Moreover, if the object represents a marker, then the learning pattern (the feature vector) based on the object belongs to a “marker” category. Furthermore, if the object represents a bush, then the learning pattern (the feature vector) based on the object belongs to a “bush” category.

The first calculating unit 15 calculates, for each category, a distance histogram that represents the distribution of the number of learning patterns belonging to the category with respect to the distances between the recognition target pattern, which is obtained by the obtaining unit 11, and the learning patterns belonging to the category.

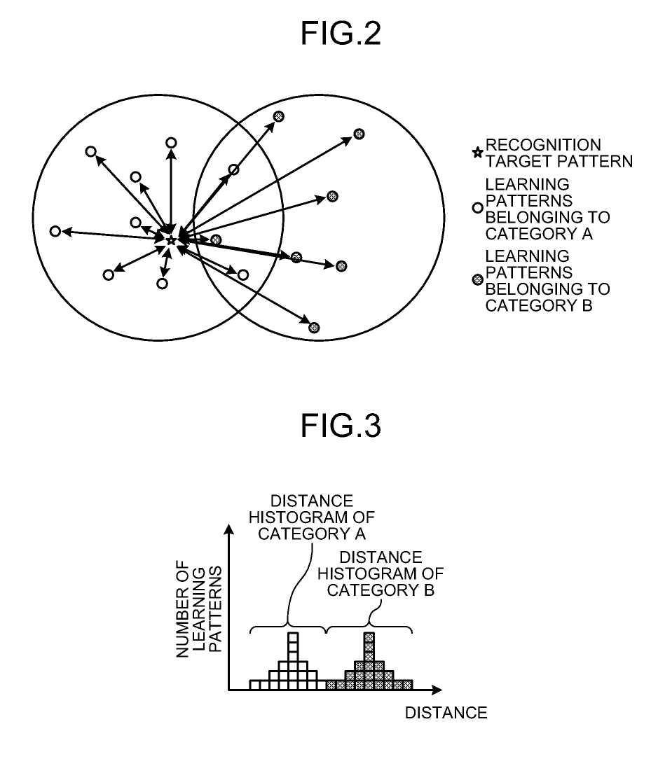

More particularly, the first calculating unit 15 obtains a plurality of learning patterns from the first memory 13, and calculates the distance between each learning pattern and the recognition target pattern obtained by the obtaining unit 11. For example, as illustrated in FIG. 2, the first calculating unit 15 calculates the Euclidean distances between the recognition target pattern and the learning patterns. In the example illustrated in FIG. 2, the Euclidean distances between the recognition target pattern and the learning patterns are illustrated as arrows.

However, the distances between the recognition target pattern and the learning patterns are not limited to the Euclidean distances. Alternatively, for example, it is possible to use an arbitrary distance metric such as the Manhattan distance, the Mahalanobis' generalized distance, or the Hamming distance.

Then, with respect to each of a plurality of categories, the first calculating unit 15 aggregates, for each calculated distance, a plurality of learning patterns belonging to that category. As a result, for example, the first calculating unit 15 calculates distance histograms as illustrated in FIG. 3. However, the first calculating unit 15 may not aggregate the learning patterns for each calculated distance. Instead, the first calculating unit 15 can aggregate, for each distance section, the number of learning patterns having the respective calculated distances within the distance section; and accordingly calculate distance histograms.

In the examples illustrated in FIGS. 2 and 3, learning patterns include learning patterns belonging to a category A and learning patterns belonging to a category B. However, that is not the only possible case. In practice, learning patterns belonging to other categories are also present.

Meanwhile, the first calculating unit 15 need not calculate the distance between the recognition target pattern and all learning patterns stored in the first memory 13 (i.e., need not consider all learning patterns as comparison targets). Alternatively, the first calculating unit 15 may calculate the distance between the recognition target pattern and some of the learning patterns stored in the first memory 13. However, in that case, it is desirable that the learning patterns possibly having shorter distances to the recognition target pattern are treated as the targets for distance calculation, and it is desirable that the learning patterns possibly having longer distances to the recognition target pattern are excluded from the targets for distance calculation.

The second calculating unit 16 analyzes the distance histogram of each of a plurality of categories, and calculates the feature value of the recognition target pattern obtained by the obtaining unit 11. Herein, it serves the purpose as long as the feature value of the recognition target pattern is determined based on the relationship between a plurality of learning patterns obtained by the first calculating unit 15 and the recognition target pattern obtained by the obtaining unit 11. In the first embodiment, it is assumed that the feature value of the recognition target pattern is an arrangement of distances serving as mode values in the distance histograms. However, that is not the only possible case.

For example, assume that C represents the number of categories of learning patterns; assume that D represents the maximum value of the distances between the recognition target pattern and the learning patterns, which are stored in the first memory 13; and assume that d_{c} (0≦d_{c}≦D) represents the distance serving as the mode value in the distance histogram (i.e., the distance having the maximum number of learning patterns) of a category c (1≦c≦C). In this case, from the distance histogram of each of a plurality of categories, the second calculating unit 16 obtains the distance d_{c} serving as the mode value of the category; and treats {d₁, . . . , d_{c}} as the feature value of the recognition target pattern.

The second memory 17 stores therein one or more classifiers used for the classification of belongingness to one or more recognition target categories. Herein, each of the one or more recognition target categories can be a category to which at least one of a plurality of learning patterns obtained by the first calculating unit 15 belongs, or can be a category to which none of the learning patterns obtained by the first calculating unit 15 belongs.

Each of the one or more classifiers classifies whether or not input data belongs to such a recognition target category which is a classification target of that classifier. More specifically, a degree of reliability is output about the fact that input data belongs to such a recognition target category which is the classification target of that classifier.

For example, when the recognition target category which is the classification target of that classifier is same as the category of a learning pattern obtained by the first calculating unit 15, as the input data (the feature value calculated by the second calculating unit 16) is closer to the recognition target category which is the classification target of that classifier, a classifier outputs the higher degree of reliability. On the other hand, when the recognition target category which is the classification target of that classifier is different than the category of a learning pattern obtained by the first calculating unit 15, as the input data (the feature value calculated by the second calculating unit 16) and the recognition target category which is the classification target of that classifier is closer to the closeness of the abovementioned two categories, a classifier outputs the higher degree of reliability. Herein, whether or not the two categories are identical is a known fact. Moreover, in the case in which the two categories are different, the closeness of the two categories is learnt during the learning of the classifier. Hence, the closeness becomes a known fact.

In the first embodiment, the one or more classifiers are assumed to be linear classifiers; and the second memory 17 stores therein the weight and the bias of each linear classifier. However, that is not the only possible case. Moreover, the linear classifiers either can be two-class classifiers that classify two classes, or can be multi-class classifiers that classify a number of classes. In the first embodiment, the explanation is given for an example in which the linear classifiers are two-class classifiers.

For example, assuming that G represents the number of recognition target categories; in order to ensure that the number of two-class linear classifiers is also equal to G, the second memory 17 store therein, for each linear classifier, a weight {w_{g1}, . . . , w_{gc}} and a bias b_{g} that are used in calculating a degree of reliability r_{g} about the fact that the input data belongs to a recognition target category g (1≦g≦G) which is the classification target of that linear classifier. Herein, for example, the weight and the bias of a linear classifier can be obtained using learning (training) samples having known correct categories prepared in advance, and by learning about the decision boundary between the learning samples belonging to the category g and the learning samples belonging to the categories other than the category g with the use of a support vector machine (SVM).

The third calculating unit 18 makes use of the feature value calculated by the second calculating unit 16 and one or more classifiers stored in the second memory 17, and calculates the degrees of reliability of the recognition target categories. More particularly, the third calculating unit 18 makes use of the feature value calculated by the second calculating unit 16 and one or more classifiers stored in the second memory 17, and calculates the degree of reliability of each of one or more recognition target categories. That is, with respect to the weight and the bias of each linear classifier stored in the second memory 17, the third calculating unit 18 makes use of the weight, the bias, and the feature value calculated by the second calculating unit 16; and calculates the degree of reliability of the recognition target category classified by the linear classifier.

In the first embodiment, the degree of reliability represents the sum of the inner product of the weight and the feature value of a linear classifier and the bias of that linear classifier. Thus, for example, the third calculating unit 18 calculates the degree of reliability r_{g} of the category g using Equation (1) given below.

$${r}_{g} = \{ \begin{matrix}{w}_{g 1} & … & {w}_{g C}\end{matrix} \} \{ \begin{matrix}{d}_{1} \\ ⋮ \\ {d}_{C}\end{matrix} \} + {b}_{g} \qquad ( 1 )$$

Then, from the degrees of reliability of the one or more recognition target categories, the third calculating unit 18 extracts the degrees of reliability of n number (n≧1) of recognition target categories having a higher probability of becoming the category of the recognition target pattern. For example, if {r₁, . . . , r_{G}} represent the degrees of reliability of G number of recognition target categories, then the third calculating unit 18 arranges n number of degrees of reliability in descending order from among the degrees of reliability {r₁, . . . , r_{G}}, and treats the n number of degrees of reliability as {u₁, . . . , uₙ}. Thus, from among the G number of degrees of reliability {r₁, . . . , r_{G}}, n number of degrees of reliability {u₁, . . . , uₙ} are extracted. Meanwhile, categories {f₁, . . . , fₙ} corresponding to the degrees of reliability {u₁, . . . , uₙ} becomes candidate categories having the ranking from 1 to n.

The determining unit 19 refers to the degrees of reliability calculated by the third calculating unit 18, and determines the category of the recognition target pattern from among a plurality of recognition target categories. More particularly, the determining unit 19 makes use of one of the n number of degrees of reliability calculated by the third calculating unit 18, and determines the category of the recognition target pattern from among the n number of recognition target categories.

For example, of the n number of degrees of reliability {u₁, . . . , uₙ} the determining unit 19 determines whether the highest degree of reliability (the first-ranked cumulative degree of reliability) u₁ exceeds a threshold value R_{fix} (an example of a second threshold value). If the highest degree of reliability u₁ exceeds the threshold value R_{fix}, then the determining unit 19 determines the category f₁ of the highest degree of reliability u₁ to be the category of the recognition·target pattern.

For example, if the highest degree of reliability u₁ does not exceed the threshold value R_{fix}, then the determining unit 19 determines whether or not a predetermined degree of reliability other than the highest degree of reliability from among the n number of degrees of reliability {u₁, . . . , uₙ} exceeds a threshold value R_{reject} (an example of a third threshold value). If the predetermined degree of reliability exceeds the threshold value R_{reject}, then the determining unit 19 determines the recognition target categories having the degrees of reliability, from among the n number of degrees of reliability {u₁, . . . , uₙ}, equal to or greater than the predetermined degree of reliability to be the candidates for the category of the recognition target pattern. Herein, the threshold value R_{reject} is assumed to be smaller than the threshold value R_{fix}. For example, if the third-ranked cumulative degree of reliability u₃ is the predetermined degree of reliability and exceeds the threshold value R_{reject}, then the recognition target categories {f₁, f₂, f₃} of the first-ranked to third-ranked cumulative degrees of reliability {u₁, u₂, u₃} become the candidates for the category of the recognition target pattern.

For example, if the predetermined degree of reliability does not exceed the threshold value R_{reject}, the determining unit 19 determines that the n number of recognition target categories do not include the category of the recognition target pattern.

Meanwhile, the method of determining the category of the recognition target pattern is not limited to the example explained above. Alternatively, for example, the determination can be such that either the recognition target category having the highest degree of reliability is determined as the category of the recognition target pattern, or it is determined that the category of the recognition target pattern is not present. Still alternatively, the determination can be such that either the recognition target categories having the degrees of reliability equal to or greater than a predetermined degree of reliability are determined as the candidates for the category of the recognition target pattern, or it is determined that the category of the recognition target pattern is not present.

The output control unit 21 outputs the category of the recognition target pattern, as is determined by the determining unit 19, to the output unit 23.

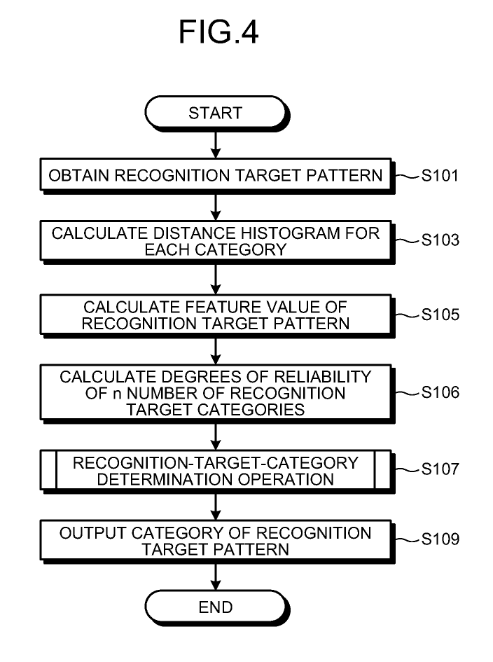

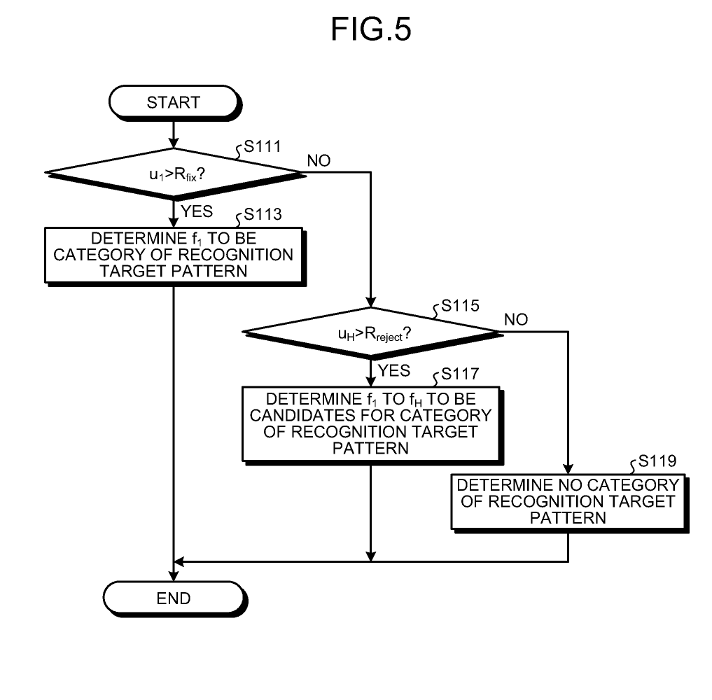

FIG. 4 is a flowchart for explaining an exemplary sequence of operations during a recognition operation performed in the recognition device 10 according to the first embodiment.

Firstly, the obtaining unit 11 obtains the recognition target pattern (Step S101).

Then, the first calculating unit 15 calculates, for each category, a distance histogram that represents the distribution of the number of learning patterns belonging to the category with respect to the distances between the recognition target pattern, which is obtained by the obtaining unit 11, and the learning patterns belonging to the concerned category (Step S103).

Then, the second calculating unit 16 analyzes the distance histogram of each of a plurality of categories, and calculates the feature value of the recognition target pattern (Step S105).

Subsequently, the third calculating unit 18 makes use of the feature value calculated by the second calculating unit 16 and one or more classifiers stored in the second memory 17; calculates the degree of reliability of each of one or more recognition target categories; and extracts the degrees of reliability of n number of recognition target categories having a higher probability of becoming the category of the recognition target pattern (Step S106).

Then, the determining unit 19 makes use of one of the n number of degrees of reliability calculated by the third calculating unit 18, and performs a recognition-target-category determination operation for determining the category of the recognition target pattern from among the n number of recognition target categories (Step S107).

Subsequently, the output control unit 21 outputs the category of the recognition target pattern, as is determined by the determining unit 19, to the output unit 23 (Step S109).

FIG. 5 is a flowchart for explaining an exemplary sequence of operations during the category determination operation performed by the determining unit 19 according to the first embodiment.

Firstly, the determining unit 19 determines whether or not the first-ranked cumulative degree of reliability u₁, from among the n number of degrees of reliability {u₁, . . . , uₙ} calculated by the third calculating unit 18, exceeds the threshold value R_{fix} (Step S111). If the first-ranked cumulative degree of reliability u₁ exceeds the threshold value R_{fix} (Yes at Step S111), then the determining unit 19 determines the category f₁ of the first-ranked cumulative degree of reliability u₁ to be the category of the recognition target pattern (Step S113).

If the first-ranked cumulative degree of reliability u₁ does not exceed the threshold value R_{fix} (No at Step S111), then the determining unit 19 determines whether or not an H-th-ranked cumulative degree of reliability u_{H} other than the first-ranked degree of reliability u₁ from among the n number of degrees of reliability {u₁, . . . , uₙ} exceeds the threshold value R_{reject} (Step S115). If the H-th-ranked cumulative degree of reliability u_{H} exceeds the threshold value R_{reject} (Yes at Step S115), then the determining unit 19 determines the categories {f₁, . . . , f_{H}} having the cumulative degrees of reliability {u₁, . . . , u_{H}}, starting from the first-ranked cumulative degree of reliability to the H-th-ranked cumulative degree of reliability, to be the candidates for the category of the recognition target pattern (Step S117).

If the H-th-ranked cumulative degree of reliability u_{H} does not exceed the threshold value R_{reject} (No at Step S115), then the determining unit 19 determines that the category of the recognition target pattern is not present (Step S119).

In this way, according to the first embodiment, as a result of using the distance histogram with respect to the recognition target pattern and the learning patterns of each category, it becomes possible to evaluate the relationship between the recognition target pattern and all learning patterns of each category. As a result, pattern recognition can be performed with enhanced recognition accuracy and enhanced robustness.

Particularly, in the first embodiment, the feature value of the recognition target pattern is an arrangement of distances serving as mode values in the distance histograms. Hence, it becomes possible to appropriately evaluate the relationship between the recognition target pattern and all learning patterns of each category. For that reason, if the degrees of reliability of one or more recognition target categories are calculated using the feature value along with one or more classifiers that are used in classifying belongingness to the recognition target categories, and if the degrees of reliability are then used to determine the category of the recognition target pattern from among the one or more recognition target categories; pattern recognition can be performed with further enhanced recognition accuracy and further enhanced robustness.

For example, in the first embodiment, if one or more recognition target categories include the “person” category, then pattern recognition about whether or not a person is present can be performed with further enhanced recognition accuracy and further enhanced robustness. That is suitable in the case of performing person recognition using a car-mounted camera.

### Second Embodiment

In a second embodiment, the explanation is given for an example in which the degrees of reliability are calculated by further using cumulative histograms each of which represents the ratio of a cumulative number that is obtained by accumulating the number of learning patterns at each distance constituting the corresponding distance histogram. The following explanation is given with the focus on the differences with the first embodiment. Thus, the constituent elements having identical functions to the first embodiment are referred to by the same names and reference numerals, and the relevant explanation is not repeated.

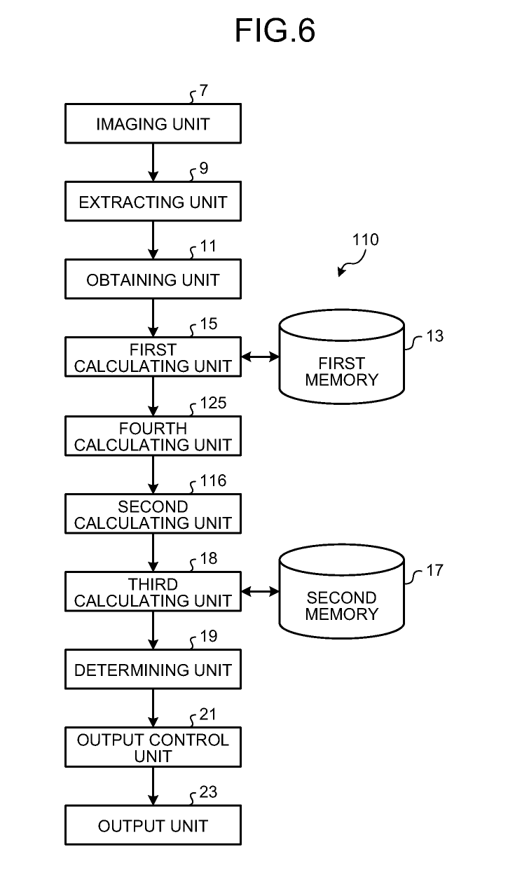

FIG. 6 is a configuration diagram illustrating an example of a recognition device 110 according to the second embodiment. As illustrated in FIG. 2, as compared to the first embodiment, the recognition device 110 according to the second embodiment differs in the way that a fourth calculating unit 125 and a second calculating unit 116 are included.

The fourth calculating unit 125 can be implemented, for example, using software, or using hardware, or using a combination of software and hardware.

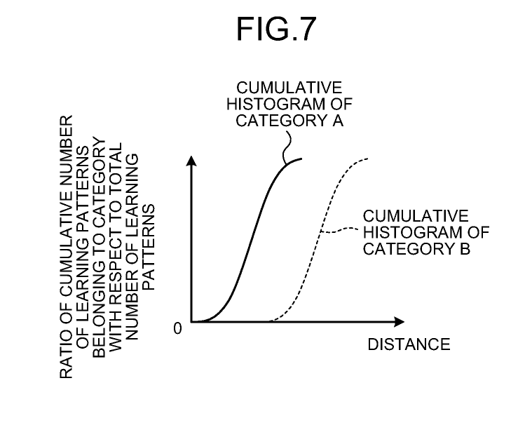

The fourth calculating unit 125 calculates, with respect to each category, a cumulative histogram that represents, for each distance constituting the corresponding distance histogram calculated by the first calculating unit 15, the ratio of a cumulative number which is obtained by accumulating the number of learning patterns at the distance. More particularly, as illustrated in FIG. 7, the fourth calculating unit 125 calculates, for each category, a cumulative histogram that represents, for each distance constituting the corresponding distance histogram, the ratio of a cumulative number, which is obtained by accumulating in ascending order of distances the number of learning patterns at the distance, with respect to the total number of learning patterns belonging to that category.

The second calculating unit 116 analyzes the cumulative histogram of each of a plurality of categories, and calculates the feature value of the recognition target pattern obtained by the obtaining unit 11. In the second embodiment, it is assumed that the feature value of the recognition target pattern is an arrangement, with respect to each cumulative histogram, of distances for which the abovementioned ratio reaches a first threshold value. However, that is not the only possible case.

For example, assume that C represents the number of categories of the learning patterns; and d_{c} represents the distance for which the abovementioned ratio reaches the first threshold value in the cumulative histogram of the category c (1≦c≦C). In that case, the second calculating unit 116 obtains the distance d_{c} of each of a plurality of categories from the cumulative histogram of the category, and treats the distances {d₁, . . . , d_{c}} as the feature value of the recognition target pattern.

However, the calculation of the feature value is not limited to the method described above. Alternatively, the feature value can be calculated using arbitrary values that are calculated from the distance histograms and the cumulative histograms. For example, the feature value can be calculated in the following manner: by setting a plurality of threshold values and using the distances for which the cumulative histograms reach the respective threshold values; or by setting a different threshold value for each category and using the distance reaching each threshold value; or setting each cumulative histogram not as the ratio of cumulative number but as the accumulation count of the learning patterns and using the distance reaching each threshold value.

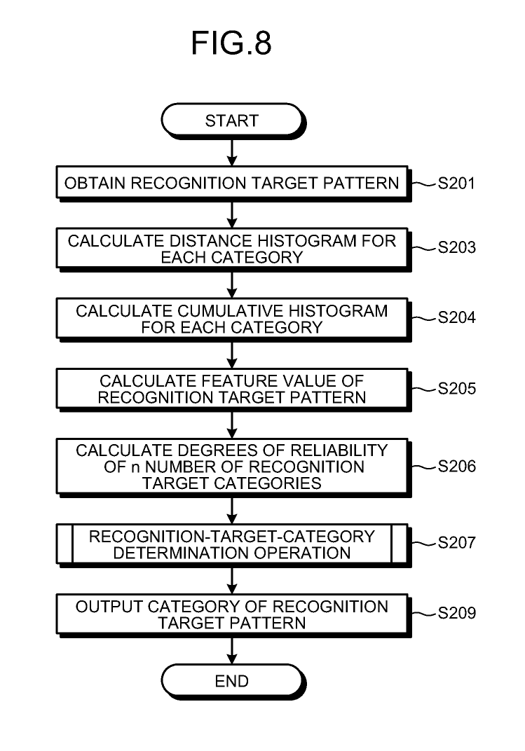

FIG. 8 is a flowchart for explaining an exemplary sequence of operations during a recognition operation performed in the recognition device 110 according to the second embodiment.

Firstly, the operations performed at Steps S201 and S203 are identical to the operations performed at Steps S101 and S103 in the flowchart illustrated in FIG. 4.

Then, the fourth calculating unit 125 calculates, for each category, a cumulative histogram that represents, for each distance constituting the corresponding distance histogram calculated by the first calculating unit 15, the ratio of a cumulative number which is obtained by accumulating the number of learning patterns at the distance (Step S204).

Subsequently, the second calculating unit 116 analyzes the cumulative histogram of each of a plurality of categories, and calculates the feature value of the recognition target pattern (Step S205).

Then, the operations performed at Steps S206 to S209 are identical to the operations performed at Steps S106 to S109 in the flowchart illustrated in FIG. 4.

In this way, according to the second embodiment, as a result of using the cumulative histogram with respect to the recognition target pattern and the learning patterns of each category, it becomes possible to evaluate the relationship between the recognition target pattern and all learning patterns of each category. As a result, pattern recognition can be performed with enhanced recognition accuracy and enhanced robustness.

### FIRST MODIFICATION EXAMPLE

In the embodiments described above, the explanation is given about an example in which the recognition target pattern and the learning patterns are feature vectors extracted from an image in which the recognition target object is captured. However, that is not the only possible case. Alternatively, it is possible to use the actual images in which the recognition target object is captured. In that case, the recognition device need not include the extracting unit 9. Moreover, the obtaining unit 11 can obtain the images taken by the imaging unit 7. Furthermore, the first calculating unit 15 can calculate, for example, the sum total of the differences between pixel values of the pixels in both images as the distance between the recognition target pattern and the learning patterns; and then calculate distance histograms.

### SECOND MODIFICATION EXAMPLE

In the embodiments described above, the explanation is given about an example in which the recognition device includes the imaging unit 7 and the extracting unit 9. However, the recognition device may not include the imaging unit 7 and the extracting unit 9. In that case, the configuration can be such that the recognition target pattern is generated on the outside and then obtained by the obtaining unit 11. Alternatively, the configuration can be such that the recognition target pattern is stored in the first memory 13 and obtained by the obtaining unit 11.

Hardware Configuration

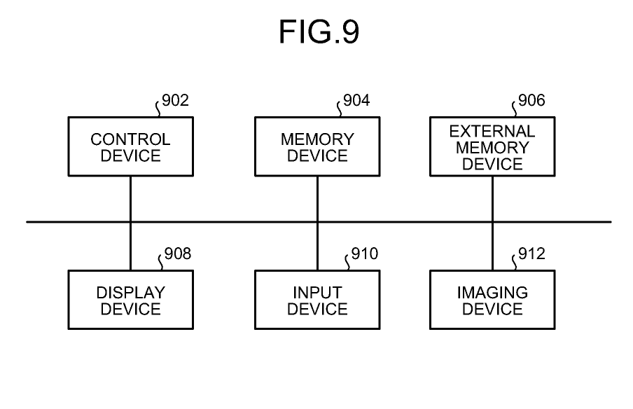

FIG. 9 is a diagram illustrating an exemplary hardware configuration of the recognition device according to the embodiments and the modification examples. Herein, the recognition device according to the embodiments and the modification examples has the hardware configuration of a commonly-used computer that includes a control device 902 such as a central processing unit (CPU); a memory device 904 such as a read only memory (ROM) or a random access memory (RAM); an external memory device 906 such as a hard disk drive (HDD); a display device 908 such as a display; an input device 910 such as a keyboard or a mouse; and an imaging device 912 such as a digital camera.

The computer programs that are executed in the recognition device according to the embodiments and the modification examples are recorded in the form of installable or executable files in a computer-readable recording medium such as a compact disk read only memory (CD-ROM), a compact disk readable (CD-R), a memory card, a digital versatile disk (DVD), or a flexible disk (FD).

Alternatively, the computer programs that are executed in the recognition device according to the embodiments and the modification examples can be saved as downloadable files on a computer connected to the Internet or can be made available for distribution through a network such as the Internet. Still alternatively, the computer programs that are executed in the recognition device according to the embodiments and the modification examples can be stored in advance in a ROM or the like.

Meanwhile, the computer programs that are executed in the recognition device according to the embodiments and the modification examples contain a module for each of the abovementioned constituent elements to be implemented in a computer. In practice, for example, a CPU reads the computer programs from an HDD and runs them such that the computer programs are loaded in a RAM. As a result, the module for each of the abovementioned constituent elements is generated in the computer.

For example, unless contrary to the nature thereof, the steps of the flowcharts according to the embodiments described above can have a different execution sequence, can be executed in plurality at the same time, or can be executed in a different sequence every time.

As described above, according to the embodiments and the modification examples, it becomes possible to enhance the recognition accuracy and the robustness.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A recognition device comprising:
a first memory to store therein a plurality of learning patterns each of which belongs to one of a plurality of categories;
an obtaining unit to obtain a recognition target pattern;
a first calculating unit to, for each of the plurality of categories, calculate a distance histogram which represents distribution of number of learning patterns belonging to the categories with respect to distances between the recognition target pattern and the learning patterns belonging to the categories;
a second calculating unit to analyze the distance histogram of each of the plurality of categories, and calculate a feature value of the recognition target pattern;
a third calculating unit to make use of the feature value and one or more classifiers used in classifying belongingness to one or more recognition target categories, and calculate degrees of reliability of the recognition target categories;
a determining unit to make use of the degrees of reliability and, from among the one or more recognition target categories, determine a category of the recognition target pattern; and
an output unit to output the determined category of the recognition target pattern.

2. The device according to claim 1, wherein
the third calculating unit calculates a degree of reliability of each of the one or more recognition target categories, and extracts degrees of reliability of n number (n≧1) of recognition target categories having a higher probability of becoming the category of the recognition target pattern, and
the determining unit makes use of any one degree of reliability from among the n number of degrees of reliability, and determines the category of the recognition target pattern from among the n number of recognition target categories.

3. The device according to claim 2, wherein
the one or more classifiers are one or more linear classifiers,
the recognition device further comprises a second memory to store therein weight and bias of each of the one or more linear classifiers, and
for the weight and the bias of each of the linear classifiers, the third calculating unit makes use of the weight, the bias, and the feature value, and calculates a degree of reliability of a recognition target category classified by the linear classifier.

4. The device according to claim 3, wherein the degree of reliability represents sum of inner product of the weight of the linear classifier and the feature value and the bias of the linear classifier.

5. The device according to claim 1, wherein the feature value is an arrangement of distances serving as mode values in the distance histograms.

6. The device according to claim 1, further comprising a fourth calculating unit to calculate, with respect to each of the categories, a cumulative histogram which represents, for each of the distances, ratio of a cumulative number obtained by accumulating the number of learning patterns constituting the distance histogram, wherein
the second calculating unit analyzes the cumulative histograms and calculates the feature value.

7. The device according to claim 6, wherein
the cumulative histogram of each of the plurality of categories represents, for each of the distances, ratio of a cumulative number, which is obtained by accumulating in ascending order of distances the number of learning patterns constituting the distance histogram of the category, with respect to total number of learning patterns belonging to the category, and
the feature value is an arrangement, with respect to each of the cumulative histograms, of distances for which the ratio reaches a first threshold value.

8. The device according to claim 2, wherein the determining unit
determines whether or not highest degree of reliability, which has highest value from among the n number of degrees of reliability, is exceeding a second threshold value, and
if the highest degree of reliability is exceeding the second threshold value, determines category of the highest degree of reliability to be the category of the recognition target pattern.

9. The device according to claim 2, wherein the determining unit
determines whether or not a predetermined degree of reliability other than highest degree of reliability, which has highest value from among the n number of degrees of reliability, is exceeding a third threshold value, and
if the predetermined degree of reliability is exceeding the third threshold value, determines recognition target categories having degrees of reliability, from among the n number of degrees of reliability, equal to or greater than the predetermined degree of reliability to be candidates for the category of the recognition target pattern.

10. The device according to claim 9, wherein, if the predetermined degree of reliability is not exceeding the third threshold value, the determining unit determines that the n number of recognition target categories do not include category of the recognition target pattern.

11. The device according to claim 1, further comprising:
an imaging unit to take an image by capturing a recognition target object; and
an extracting unit to extract the recognition target pattern from the image, wherein
the obtaining unit obtains the recognition target pattern that has been extracted.

12. A recognition method comprising:
obtaining a recognition target pattern;
obtaining, from a memory that stores therein a plurality of learning patterns each of which belongs to one of a plurality of categories, the plurality of learning patterns and calculating, for each of the plurality of categories, a distance histogram which represents distribution of number of learning patterns belonging to the categories with respect to distances between the recognition target pattern and the learning patterns belonging to the categories;
analyzing the distance histogram of each of the plurality of categories and calculating a feature value of the recognition target pattern;
making use of the feature value and one or more classifiers used in classifying belongingness to one or more recognition target categories, and calculating degrees of reliability of the recognition target categories;
making use of the degrees of reliability and determining, from among the one or more recognition target categories, a category of the recognition target pattern; and
outputting the determined category of the recognition target pattern.

13. A computer program product comprising a computer readable medium including programmed instructions, wherein the instructions, when executed by a computer, cause the computer to perform:
obtaining a recognition target pattern;
obtaining, from a memory that stores therein a plurality of learning patterns each of which belongs to one of a plurality of categories, the plurality of learning patterns and calculating, for each of the plurality of categories, a distance histogram which represents distribution of number of learning patterns belonging to the categories with respect to distances between the recognition target pattern and the learning patterns belonging to the categories;
analyzing the distance histogram of each of the plurality of categories and calculating a feature value of the recognition target pattern;
making use of the feature value and one or more classifiers used in classifying belongingness to one or more recognition target categories, and calculating degrees of reliability of the recognition target categories;
making use of the degrees of reliability and determining, from among the one or more recognition target categories, a category of the recognition target pattern; and
outputting the determined category of the recognition target pattern.
